(19) United States
(12) Patent Application Publication
(10) Pub. No.: US 2024/0388885 A1
(43) Pub. Date: Nov. 21, 2024

(54) METHOD AND SYSTEM FOR SUPPORTING EXPEDITED ROAMING IN AN EVPN ENVIRONMENT

(71) Applicant: Arista Networks, Inc., Santa Clara, CA (US)

(72) Inventors: Kumar Narayanan, Saratoga, CA (US); Venkata Ramchandra Murthy Jonnalagadda, Fremont, CA (US)

(21) Appl. No.: 18/318,619

(22) Filed: May 16, 2023

(51) Int. Cl. H04W 8/12

(52) U.S. Cl. CPC H04W 8/12; H04L 12/4641

(57) ABSTRACT

A method of operating a wireless access point is provided. The method can include connecting with a host and determining whether the host has roamed from the wireless access point to an additional wireless access point. The method can further include activating a tunnel connecting the wireless access point to the additional wireless access point subsequent to determining that the host has roamed from the wireless access point to the additional wireless access point. The method can further include forwarding data packets from the wireless access point to the additional wireless access point via the tunnel. The tunnel can be temporarily created or established based on a configurable timer.

### BACKGROUND

This relates to network devices, and more particularly, to network devices configured to support roaming of end-hosts in a wireless network.

Campus or enterprise networks that connect end-hosts such as personal computers, tablets, IP (internet protocol) phones, and IP cameras can be operated using an OSI (Open Systems Interconnection) Layer 2 based network topology that uses Layer 2 switches as bridge devices to forward Ethernet frames from one interface to another based on the Layer 2 MAC (Media Access Control) address. Such Layer 2 (L2) based networking topology employs a learn-and-flood model that facilitates in the roaming of end-hosts from one wireless access point to another by retaining connectivity and application session over a short period of time when the exact location of the MAC address of the roaming end-host is not yet clear. Inherently, the learning-and-flood mechanism allows network elements to learn the location of the MAC address faster as the end-host roams from one wireless access point to another in a campus or enterprise network deployed using the L2 network topology.

This advantage, however, goes away when network deployments transition from the L2-based topology to a Layer 3 (L3) based networking topology where network connectivity is realized using IP routing functions instead of the more basic L2 switching. L3-based network deployments, however, do not employ the learn-and-flood model and can take some time for the MAC table to update when an end-host roams from one wireless access point to another. If care is not taken, session connectivity can be lost before the MAC table is updated. It is within such context that the embodiments herein arise.

### BRIEF DESCRIPTION OF THE DRAWINGS

FIG. 1 is a diagram of an illustrative system that employs a hierarchical networking model in accordance with some embodiments.

FIG. 2 is a diagram of an illustrative access layer switch in accordance with some embodiments.

FIG. 3 is a diagram of an illustrative wireless access point in accordance with some embodiments.

FIG. 4 is a diagram showing how an end-host can roam from one wireless access point to another and how a tunnel can be established between wireless access points in accordance with some embodiments.

FIG. 5 is a flow chart of illustrative steps for operating one or more network elements shown in FIG. 4 when an end-host roams from one wireless access point to another wireless access point in accordance with some embodiments.

FIG. 6 is a flow chart of illustrative steps for operating one or more network elements shown in FIG. 4 when an end-host roams from one wireless access point to another wireless access point and then to yet another wireless access point in accordance with some embodiments.

FIG. 7 is a diagram showing how an end-host can roam from one wireless access point to another and how a tunnel can be established between access layer switches in accordance with some embodiments.

### DETAILED DESCRIPTION

A network can convey network traffic (e.g., in the form of one or more packets, one or more frames, etc.) between host devices. To properly forward the network traffic, the network can include a number of network devices. Some of these network devices may implement an Ethernet Virtual Private Network (EVPN) by exchanging network reachability information in the form of EVPN route information with one another and by processing the exchanged information. These network devices are sometimes referred to herein as EVPN peer network devices, EVPN peer devices, EVPN devices, and/or EVPN speakers.

Configurations in which the exchange of EVPN route information (e.g., MAC and IP address advertisement route information) can occur using Border Gateway Protocol (BGP), or more specifically Multiprotocol BGP (MP-BGP), and/or with Virtual Extensible LAN (VXLAN) or Multiprotocol Label Switching (MPLS) tunneling technology (e.g., using VXLAN or MPLS infrastructure, MPLS labels, etc.) are sometimes described herein as illustrative examples. If desired, the exchange of network reachability information can occur with other types of control plane routing protocol and/or utilizing other types of core network overlay infrastructure.

EVPN and VXLAN together can provide large enterprises with a common framework for managing their campus and data center networks. EVPN and VXLAN based networking architectures can support efficient Layer 2 and Layer 3 network connectivity with scale, simplicity, and agility. EVPN and VXLAN based network topologies can also decouple the underlay (physical) network topology from the overlay (virtual) network topology. The use of overlays enables flexibility in providing Layer 2 and Layer 3 connectivity between endpoints across campus and data centers while maintaining a consistent underlay architecture.

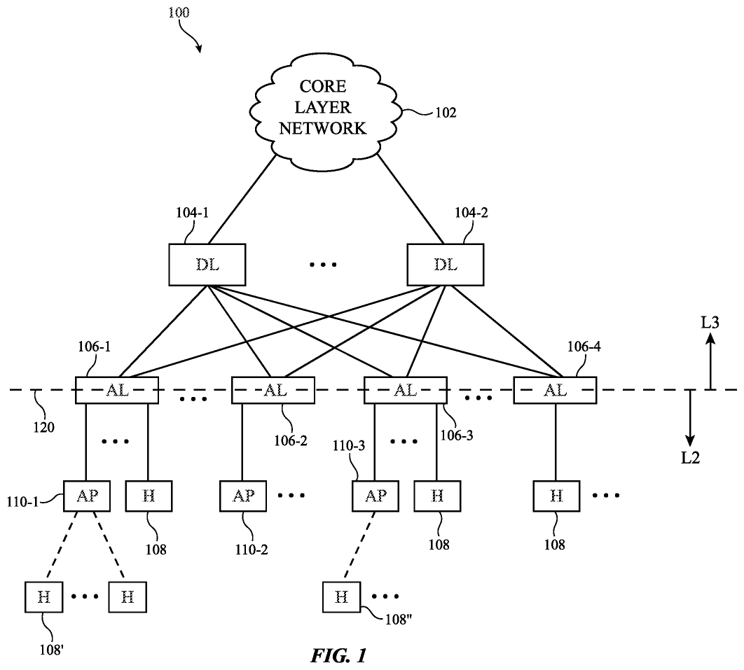

In accordance with some embodiments, EVPN can be implemented using a hierarchical networking model such as the hierarchical networking model of system (or network) 100 in FIG. 1. As shown in FIG. 1, system 100 can include a core layer with a core layer network 102, a distribution layer having distribution layer (DL) switches 104-1 and 104-2, and an access layer having access layer (AL) switches 106-1, 106-2, 106-3, and 106-4. Each layer in this hierarchical model can help provide the necessary functionality for an enterprise/campus network. The core layer network 102 can include one or more core switches that are generally located within the high-speed switching backbone or physical core of network 100 and that serve as a gateway to a wide area network (WAN) or the Internet (e.g., to serve as the final aggregation point for the overall network). Core layer network 102 is thus sometimes referred to as the “backbone” of the network. The core layer 102 should generally provide fast transport, high reliability, redundancy, fault tolerance, low latency and good manageability, avoidance of CPU intensive packet manipulation caused by security, inspection, quality of service (QOS) classification, or other processes, and QoS functions.

The distribution layer switches (e.g., DL switches 104-1 and 104-2) can serve as a bridge or link between the core layer network 102 and the access layer switches 106. The distribution layer enables aggregation of routes by providing route summaries to the core layer 102. The distribution layer switches are therefore sometimes referred to as “aggregation” switches or “spine” switches in a spine-leaf network architecture. The distribution layer switches 104 can be configured to ensure that data packets are properly routed between subnets and VLANs (virtual local area networks) in an enterprise network. In campus LANs, the distribution layer can provide routing between VLANs and can also apply security and QoS policies. In general, the distribution layer switches 104 can be configured to provide policy based connectivity, redundancy and load balancing, aggregation of LAN/WAN connections, QoS functions, security filtering, address or area aggregation, departmental or workgroup access, broadcast or multicast domain definition, routing between VLANs, media translations (e.g., translating between Ethernet and Token Ring), redistribution between different routing protocols or routing domains, demarcation between and static and dynamic routing protocols, and other distribution layer functions. Although only two distribution layer switches such as 104-1 and 104-2 are shown in the example of FIG. 1, system 100 can generally include two or more DL/aggregation switches, two to five DL/aggregation switches, five to ten DL/aggregation switches, ten to 100 DL/aggregation switches, or hundreds or thousands of DL/aggregation switches.

The access layer switches (e.g., AL switches 106-1, 106-2, 106-3, and 106-4) can be used to facilitate the connection of end-host devices to the network (e.g., to provide user access to local segments on the network). The access layer can be characterized by switched LAN segments in a campus environment. Microsegmentation using access layer switches 106 provides high bandwidth to different workgroups by reducing the number of devices on the Ethernet segments. Access layer switches can sometimes be referred to as “leaf” switches in a spine-leaf network architecture. In general, the access layer switches 106 can be configured to provide Layer 2 (L2) switching, high availability, port security, broadcast suppression, QoS classification, trust classification, rate limiting and policing, ARP (Address Resolution Protocol) inspection, virtual access control lists, network access control, maintenance of auxiliary VLANs, and other access layer functions. Although only four access layer switches such as 106-1, 106-2, 106-3, and 106-4 are shown in the example of FIG. 1, system 100 can generally include two or more access layer switches, two to five access layer switches, five to ten access layer switches, ten to 100 access layer switches, or hundreds or thousands of access layer switches.

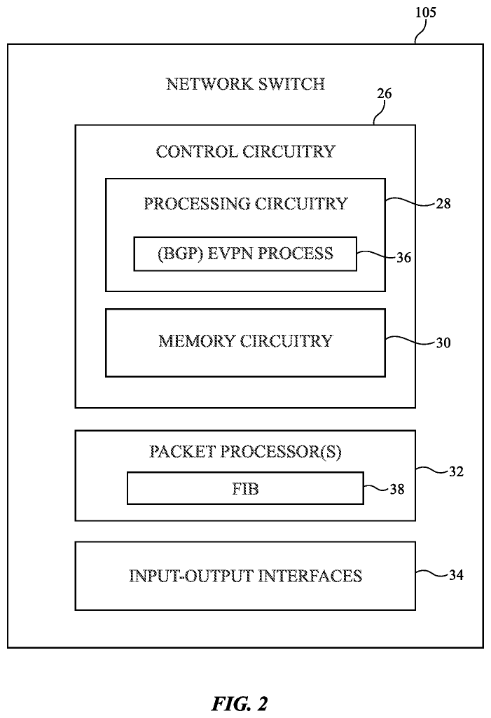

FIG. 2 is a diagram of an illustrative network device such as network switch 105. Network switch 105 can represent an access layer switch 106, a distribution layer switch 104, or other types of network elements in system 100. Network switch 105 can be an EVPN network device configured to exchange routing information with other EVPN peer devices (e.g., using BGP). As shown in FIG. 2, network switch 105 may include control circuitry 26 having processing circuitry 28 and memory circuitry 30, one or more packet processors 32, and input-output interfaces 34 disposed within a housing of switch 105. In one illustrative arrangement, network switch 105 may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network switch 105 may be a fixed-configuration network device (e.g., a fixed-configuration switch having a fixed number of ports and/or a fixed hardware configuration).

Processing circuitry 28 may include one or more processors or processing units based on central processing units (CPUs), based on graphics processing units (GPUs), based on microprocessors, based on general-purpose processors, based on host processors, based on microcontrollers, based on digital signal processors, based on programmable logic devices such as a field programmable gate array device (FPGA), based on application specific system processors (ASSPs), based on application specific integrated circuit (ASIC) processors, and/or based on other processor architectures.

Processing circuitry 28 may run (execute) a network device operating system and/or other software/firmware that is stored on memory circuitry 30. Memory circuitry 30 may include non-transitory (tangible) computer readable storage media that stores the operating system software and/or any other software code, sometimes referred to as program instructions, software, data, instructions, or code. As an example, the BGP and/or EVPN routing functions performed by network switch 105 described herein may be stored as (software) instructions on the non-transitory computer-readable storage media (e.g., in portion(s) of memory circuitry 30 in network switch 105). The corresponding processing circuitry (e.g., one or more processors of processing circuitry 28 in network switch 105) may process or execute the respective instructions to perform the corresponding BGP and/or EVPN routing functions.

Memory circuitry 30 may be implemented using non-volatile memory (e.g., flash memory or other electrically-programmable read-only memory configured to form a solid-state drive), volatile memory (e.g., static or dynamic random-access memory), hard disk drive storage, removable storage devices (e.g., storage device removably coupled to switch 105), and/or other storage circuitry. Processing circuitry 28 and memory circuitry 30 as described above may sometimes be referred to collectively as control circuitry 26 (e.g., implementing a control plane of network switch 105).

As just a few examples, processing circuitry 28 may execute network device control plane software such as operating system software, routing policy management software, routing protocol agents or processes (e.g., BGP and/or EVPN process 36), routing information base agents, and other control software, may be used to support the operation of protocol clients and/or servers (e.g., to form some or all of a communications protocol stack such as the TCP/IP stack), may be used to support the operation of packet processor(s) 32, may store packet forwarding information, may execute packet processing software, and/or may execute other software instructions that control the functions of network switch 105 and the other components therein.

Packet processor(s) 32 may be used to implement a data plane or forwarding plane of network switch 105. Packet processor(s) 32 may include one or more processors or processing units based on central processing units (CPUs), based on graphics processing units (GPUs), based on microprocessors, based on general-purpose processors, based on host processors, based on microcontrollers, based on digital signal processors, based on programmable logic devices such as a field programmable gate array device (FPGA), based on application specific system processors (ASSPs), based on application specific integrated circuit (ASIC) processors, and/or based on other processor architectures. Packet processor 32 may receive incoming network traffic via input-output (ingress-egress) interfaces 34, parse and analyze the received network traffic, process the network traffic based on packet forwarding decision data (e.g., in a forwarding information base or “FIB” 38) and/or in accordance with network protocol(s) or other forwarding policy, and forward (or drop) the network traffic accordingly. The forwarding information base (FIB) 38 is a table that stores information about how to forward network traffic and is sometimes referred to or defined as a forwarding table or a MAC forwarding table. FIB 38 can be used by switch 105 to determine the next hop and an egress interface for a data packet in order to reach its intended destination. The packet forwarding decision data may be stored on a portion of memory circuitry 30 and/or other memory circuitry integrated as part of or separate from packet processor 32.

Input-output interfaces 34 may include different types of communication interfaces such as Ethernet interfaces (e.g., one or more Ethernet ports), optical interfaces, a Bluetooth interface, a Wi-Fi® interface, and/or other networking interfaces for connecting network switch 105 to the Internet, a local area network, a wide area network, a mobile network, and generally other network device(s), peripheral devices, and other computing equipment (e.g., host equipment such as server equipment, user equipment, etc.). As an example, input-output interfaces 34 may include ports or sockets to which corresponding mating connectors of external components can be physically coupled and electrically connected. Ports may have different form-factors to accommodate different cables, different modules, different devices, or generally different external equipment.

In configurations in which network switch 105 implements an EVPN with EVPN peer devices using BGP, processing circuitry 28 on network switch 105 may execute a BGP EVPN process 36 (sometimes referred to herein as BGP EVPN agent 36). BGP EVPN process 36 may manage and facilitate operations as defined by or relevant to BGP and/or EVPN such as the exchange of network layer reachability information (e.g., EVPN NLRIs in the form of different EVPN routes) with other peer devices and the processing of the exchanged information. If desired, EVPN agent or process 36 may be implemented separately from a BGP agent or process.

While BGP EVPN process 36 is sometimes described herein to perform respective parts of BGP and/or EVPN operations for switch 105, this is merely illustrative. Processing circuitry 28 may be organized in any suitable manner (e.g., to have any other agents or processes instead of or in addition to a single BGP EVPN process 36) to perform different parts of the BGP and/or EVPN operations. Accordingly, processing circuitry 28 may sometimes be described herein to perform the BGP and/or EVPN operations instead of specifically referring to one or more agents, processes, and/or the kernel executed by processing circuitry 28.

Referring back to FIG. 1, the access layer switches 106 can be connected to one or more end-hosts 108. End-hosts 108 can represent one or more personal computers (PCs), one or more tablets, one or more IP (Internet Protocol) phones (e.g., smartphones), one or more IP cameras (e.g., security cameras), one or more printers, one or more smart televisions, one or more game consoles, one or more servers, or other types of end-hosts. End-hosts 108 are sometimes referred to as hosts, clients, or user devices. In the example of FIG. 1, access layer switches 106-1, 106-3, and 106-4 are each connected to at least one end-host 108. The access layer switches 106 can also be connected to one or more wireless access points (APs). While the access layer switches 106 can provide PoE (Power-over-Ethernet) and also physical connectivity to the rest of the enterprise/campus network, the access points allow additional end-hosts to connect wirelessly to each access point. In general, each access layer switch 106 and each wireless access point 110 can be connected to one or more end-hosts 108, two to ten end-hosts 108, or more than ten end-hosts 108.

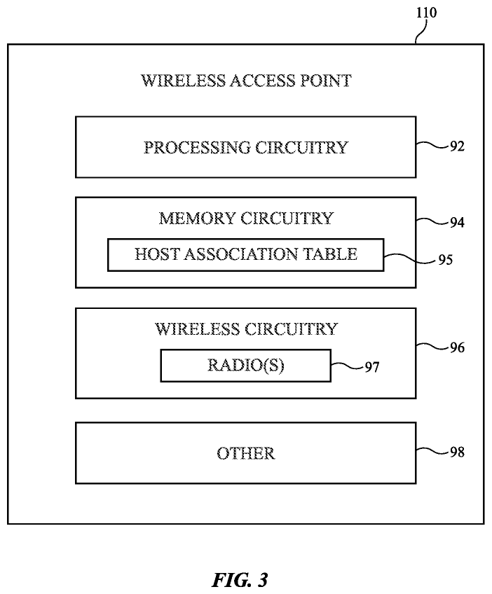

FIG. 3 is a diagram of an illustrative wireless access point 110. Wireless access point 110 can optionally be coupled to one or more associated wireless controllers. For example, different sets of access points can be coupled to different controllers in a distributed fashion. As another example, access point 110 may be coupled to a redundant (back-up) controller. As shown in FIG. 3, wireless access point 110 can be a network device that includes processing circuitry 92, memory circuitry 94, wireless circuitry 96, and other components 98 such as input-output interfaces or ports. In particular, processing circuitry 92 may include one or more processors or processing units based on microprocessors on general-purpose processors, microcontrollers, digital signal processors, programmable logic devices, application specific system processors (ASSPs), application specific integrated circuit (ASIC) processors, etc. Memory circuitry 94 may include volatile memory such as dynamic random-access memory, static random-access memory, etc., and non-volatile memory such as hard-drive storage, solid-state storage, flash memory, etc.

As an example, memory circuitry 94 can be used to store a host association table such as host association table 95 that includes a list of MAC addresses associated with end-hosts (clients) that are currently wirelessly connected to wireless access point 110. Host association table 95 is sometimes referred to as a client association table. When an end-host first wirelessly connects to a wireless access point 110, the host association table 95 on that access point can be updated to include the MAC address of the newly wirelessly connected end-host. When the end-host roams away or is otherwise disconnected from the wireless access point 110, the host association table 95 on that access point can be updated to remove the MAC address of the existing end-host. In some embodiments, memory circuitry 94 can also be configured to maintain a host association table that keeps track of end-hosts wirelessly connected to a neighboring wireless access point (sometimes referred to as a radio neighbor). The table listing end-hosts for a radio neighbor can sometimes be referred to and defined as a “radio neighbor host association table.”

In general, the operations described herein relating to the operation of wireless access point 110 and/or other relevant operations may be stored as (software) instructions on one or more non-transitory computer-readable storage media (e.g., memory circuitry 94) in wireless access point 110. The corresponding processing circuitry (e.g., processing circuitry 92 in wireless access point 110 for these one or more non-transitory computer-readable storage media may process the respective instructions to perform the corresponding wireless access point operations, or more specifically, radio operations. Some portions of processing circuitry 92 and some portions of memory circuitry 94, collectively, may sometimes be referred to herein as the “control circuitry” of wireless access point 110 because the two are often collectively used to control one or more components (e.g., radio components) of wireless access point 110 to perform corresponding operations (e.g., by sending and/or receiving requests, control signals, data, etc.).

Wireless access point 110 may include wireless (communication) circuitry 96 to wirelessly communicate with end-host devices (e.g., host or client devices 108 in FIG. 1). Wireless circuitry 96 may include one or more radios 97 (e.g., Wi-Fi® radios, cellular radios, baseband processors, etc.), radio-frequency transceiver circuitry, radio-frequency front-end circuitry, and one or more antennas. One or more radios 97 may use the one or more antennas to transmit radio-frequency signals to and receive radio-frequency signals from one or more end-host devices or with one or more neighboring wireless access points. While wireless circuitry 96 is shown as a separate element from processing circuitry 92, this is merely illustrative. If desired, portions of wireless circuitry 96 with radio functionalities may be implemented on portions of processing circuitry 92.

Wireless access point 110 may include other components 98 such as one or more input-output interfaces or ports such as Ethernet ports or other types of network interface ports that provided connections to other network elements (e.g., switches, routers, modems, controllers) in the network, power ports through which power is supplied to wireless access point 110, or other ports. In general, input-output components in wireless access point 110 may include communication interface components that provide a Bluetooth® interface, a Wi-Fi® interface, an Ethernet interface (e.g., one or more Ethernet ports), an optical interface, and/or other networking interfaces for connecting wireless access point 110 to the Internet, a local area network, a wide area network, a mobile network, other types of networks, and/or to another network device, peripheral devices, and/or other electronic components

If desired, other components 98 on wireless access point 110 may include other input-output devices such as devices that provide output to a user such as a display device (e.g., one or more status lights) and/or devices that gather input from a user such as one or more buttons. If desired, other components 98 on wireless access point 110 may include one or more sensors such as radio-frequency sensors. If desired, wireless access point 110 may include other components 98 such as a system bus that couples the components of network device 110 to one another, to power management components, etc. In general, each component within wireless access point 110 may be interconnected to the control circuitry (e.g., processing circuitry 92 and/or memory circuitry 94) in wireless access point 110 via one or more paths that enable the reception and transmission of control signals and/or other data.

Referring back to the example of FIG. 1, access layer switch 106-1 is connected to a first access point 110-1, access layer switch 106-2 is connected to a second access point 110-2, and access layer switch 106-3 is connected to a third access point 110-3. One or more end-hosts can be wirelessly connected to each access point. In the example of FIG. 1, access point 110-1 can be wirelessly connected to one or more end-hosts 108′, whereas access point 110-3 can be wirelessly connected to one or more end-hosts 108″. Access points 110 can provide wireless connectivity using IEEE 802.11 protocols (sometimes referred to as Wi-Fi®) or other suitable wireless local area network (WLAN) or wireless personal area network (WPAN) protocols. The access points 110 can act as a protocol gateway to translate 802.11 wireless frames to 802.3 Ethernet frames (as an example). The access points 110 can be Layer 2 network elements configured to transmit Ethernet frames on their Ethernet uplink path towards a connected access layer switch. The corresponding access layer switch can then switch the received frames based on its MAC address and a switching/routing table on that switch.

In conventional network deployments, the transition from Layer 2 (L2) switching to Layer 3 (L3) routing occurs at the distribution layer. The L2 and L3 layers refer to the data link layer and the network layer, respectively, of the 7-layer OSI (Open Systems Interconnection) model. While the L2 layer is primarily responsible for the functional and procedural means of transferring data between network entities, the L3 layer is responsible for the logical addressing and IP routing of data over the network.

In recent years, there is a trend towards migrating to a model where the L3 routing/forwarding occurs in the access layer instead of the distribution layer (see, e.g., L2 to L3 transition as marked by dotted line 120 in the example of FIG. 1). Moving the L3 boundary to the access layer can remove peculiarities such as data loops due to the Spanning Tree Protocol, can enable a better summarization of routes, can enable L3 address to be learned a priori, etc.

The use of wireless access points 110 to support Wi-Fi® can enable roaming of end-hosts from one wireless access point to another. Roaming allows end-hosts to move across a campus or office floor without losing wireless connectivity by handing off end-host states between different access points. For example, as a user moves away from one access point to another access point, the states of the user's device (sometimes referred to as end-host states) can be securely instantiated at the destination access point. Roaming, however, has strict timing requirements. If it takes too long to route the traffic to the user's device when the user roams from one access point to another, the application can time out, and the user device will need to reestablish the wireless connection. This may not be a major issue for web browsing but can be problematic for more engaging applications such as voice calls and video conferencing where a disruption to wireless connectivity can result in unpleasant user experience.

The hierarchical networking model of FIG. 1 can be used to run EVPN. EVPN uses the BGP protocol to carry the MAC address of an end-host to all the switches that participate in the EVPN. Using the model of FIG. 1 where the L3 functions are provided in the access layer, the access layer switches will not be able to flood the MAC address of a roaming end-host. For example, consider a scenario in which a smartphone (end-host) 108′ roams from access point 110-1 to access point 110-3. The smartphone 108′ can have an exemplary MAC address M. When the smartphone roams and shows up at access point 110-3, access point 110-3 will inform the associated access layer switch 106-3 of this newly incoming MAC address M (e.g., access point 110-3 can send a link-local packet to switch 106-3 after MAC address M is seen by access point 110-3 during this roaming event). Access layer switch 106-3 cannot flood this MAC address. Instead, access layer switch 106-3 running EVPN will send the arrival of the new MAC address M to its control plane, which is realized in software. Ultimately, the news of MAC address M will show up in the BGP process running as a BGP software agent on an access layer switch. The BGP process running on the switch can then schedule an update message to all other EVPN peers.

In some cases, the BGP process schedules this update periodically and in the best case, the arrival of a new MAC address triggers an immediate BGP advertisement. In any case, it can take up to 100 milliseconds or hundreds of milliseconds for the BGP updates to propagate through the associated distribution and access layer switches depending on how busy the CPU on the access layer or distribution layer switch running the control plane software is. In the example of FIG. 1, when the smartphone 108′ is detected by access layer switch 106-3 and after switch 106-3 learns of the smartphone's MAC address M, a BGP advertisement can be sent from access layer switch 106-3 to distribution layer switches 104-1 and 104-2. Thereafter, the distribution layer switches 104-1 and 104-2 can then send an advertisement toward the original access layer switch 106-1. In response, the control plane of access layer switch 106-1 receives the advertisement and updates its forwarding table. This sequence of events can take some time. During this time before the BGP advertisement has been received by the original access layer switch 106-1, it is possible that traffic intended for MAC address M will be sent to switch 106-1 by the upstream switches such as DL switch 104-1 since the upstream switches are still under the impression that smartphone 108′ is wirelessly connected to switch 106-1. Since the end-host has already roamed to access point 110-3, access point 110-1 will drop such arriving frames. This traffic black hole will exist until the BGP updates occur on all northbound switches and can lead to disruption in communication and negative user experience.

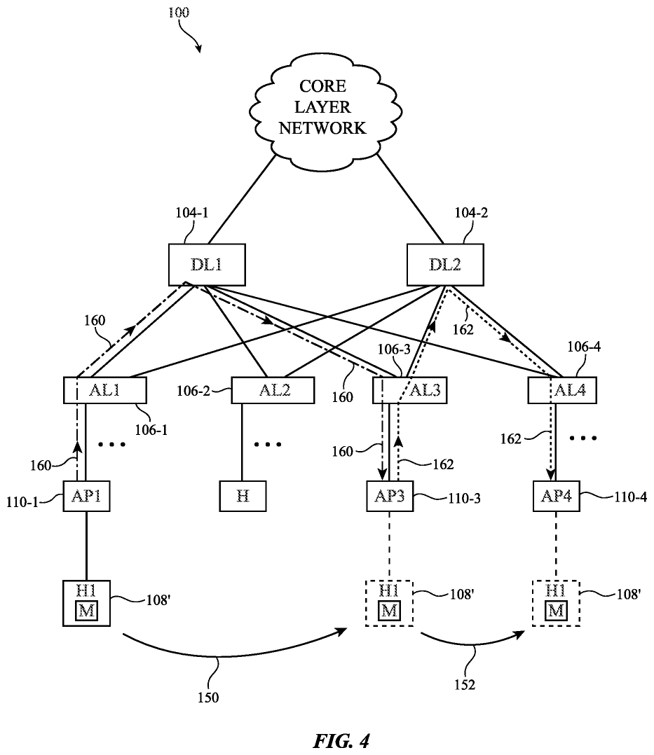

In accordance with an embodiment, a method is provided that can fill this blackhole by temporarily forwarding traffic from an old access point to a new access point when an end-host roams from the old access point to the new access point. FIG. 4 is a diagram showing how an end-host such as host 108′ can roam from one wireless access point to another wireless access point. Host 108′ can have an illustrative MAC address M and can also be referred to herein as “H1.” In the example of FIG. 4, end-host H1 roams from a first wireless access point 110-1 (also referred to herein as “AP1”) to another wireless access point 110-3 (also referred to herein as “AP3”), as indicated by arrow 150 (e.g., client 108′ can roam from a wireless coverage area of AP1 to a wireless coverage area of AP3).

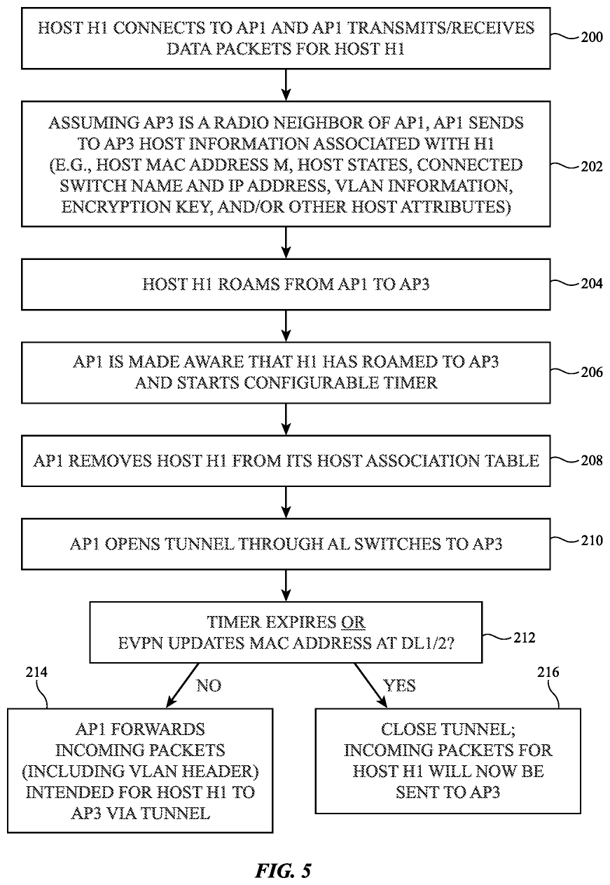

FIG. 5 is a flow chart of illustrative steps for operating one or more network elements shown in FIG. 4 when, for example, end-host H1 roams from AP1 to AP3. During the operations of block 200, end-host H1 can connect wirelessly to wireless access point AP1. Once end-host H1 has established a wireless session with wireless access point AP1, wireless access point AP1 can transmit and receive data packets for end-host H1.

During the operations of block 202, assuming wireless access point AP3 is a radio neighbor of wireless access point AP1, AP1 can send to radio neighbor AP3 host information associated with end-host H1. A “radio neighbor” can refer to or be defined herein as a radio communication device that is in close proximity to another radio communication device. Radio neighbors can have overlapping coverage areas and can communicate with one another. Here, wireless access point AP1 can transmit to AP3 information such as host MAC address M, host states, the name and IP address of the currently wirelessly connected switch (e.g., the name and IP address of access layer switch 106-1, also referred to herein as “AL1”), associated VLAN information, one or more encryption keys if some form of encryption is employed, and/or other host attributes. In some embodiments, a wireless controller associated with one or more of the access points 110 in network 100 can provide the host information to AP3.

During the operations of block 204, end-host H1 roams from wireless access point AP1 to wireless access point AP3. This can occur, for example, when a user carrying the end-host device H1 moves from the wireless coverage area of AP1 to the wireless coverage area of AP3 (e.g., when the user walks across a campus or enterprise office floor).

During the operations of block 206, wireless access point AP1 can be made aware that end-host H1 has roamed to wireless access point AP3. For example, once wireless access point AP3 detects the presence of MAC address M, wireless access point AP3 can inform AP1 that AP3 has detected and now owns the MAC address M of the roaming end-host H1. Once wireless access point AP1 learns from AP3 that host H1 has roamed to AP3, wireless access point AP1 can start a configurable timer. The duration of the configurable timer may determine how long data packets should be forwarded from AP1 to AP3. The timer can have a configurable value that is at least 100 ms (milliseconds), 100-500 ms, 500-1000 ms, at least 1000 ms, 1000-2000 ms, 2000-4000 ms, 100-4000 ms, or more than 4000 ms.

During the operations of block 208, wireless access point AP1 can remove end-host H1 from its host association table (see, e.g., host association table 95 in FIG. 3). For instance, wireless access point AP1 can update its host association table 95 to remove the MAC address M associated with H1. At this time, wireless access point AP3 can optionally update its host association table to now include the MAC address M of the entering end-host H1. If desired, wireless access point AP1 can optionally update its radio neighbor host association table to now include MAC address M for radio neighbor AP3.

During the operations of block 210, wireless access point AP1 and/or AP3 can create or establish a tunnel through the access layer switches to wireless access point AP3. As shown in FIG. 4, wireless access point AP1 can create or establish a tunnel such as tunnel 160 between AP1 and AP3. In certain scenarios, wireless access point AP3 can create or establish tunnel 160. Tunnel 160 can be a VXLAN (Virtual Extensible LAN) tunnel, EoGRE (Ethernet over Generic Routing Encapsulation) tunnel, GRE tunnel, BGP tunnel, L2TP (Layer 2 Tunneling Protocol) tunnel, SSL (Secure Sockets Layer) tunnel, PPTP (Point-to-Point Tunneling Protocol) tunnel, MPLS (Multiprotocol Label Switching) tunnel, a virtual tunnel, and/or other types of networking tunnels. Tunnel 160 connecting one wireless AP to another wireless AP can sometimes be referred to and defined herein as an AP-to-AP tunnel. In the example of FIG. 4, tunnel 160 can be coupled through the access layer and distribution layer switches (e.g., see tunnel 160 traversing switches AL1, DL1, and AL3). This is illustrative. In other embodiments, tunnel 160 need not necessarily traverse any distribution layer or aggregation switches so long as an IP route is formed between wireless access points AP1 and AP3. Although the operations of block 210 are shown to occur after the operations of block 208, this need not be the case. If desired, the operations of block 210 can be performed before or in parallel (simultaneously) with the operations of block 208 or block 206.

During the operations of block 212, wireless access point AP1 can check whether the configurable time has expired or the EVPN can update the MAC address M of the roaming host H1 at the distribution layer switches (e.g., at switches DL1 and DL2) and/or the access layer switches (e.g., at least AL1 and AL3) via the BGP advertisement process. This process by which the MAC address of a roaming end-host is finally updated at the access layer and distribution layer switches is sometimes referred to and defined herein as EVPN or BGP “convergence.” An EVPN/BGP update can include adding or removing the MAC address of an end-host from the FIB of one or more access layer and/or distribution layer switches.

If the configurable timer on wireless access point AP1 has not expired and if EVPN has not yet updated the MAC address M at the distribution layer switches (i.e., before EVPN/BGP convergence), then processing may proceed to block 214. During the operations of block 214, wireless access point AP1 can be configured to forward any incoming packets (including the VLAN header) that are intended for end-host H1 to the destination wireless access point AP3 via tunnel 160. Configured and operated in this way, all traffic intended for end-host H1 will be appropriately directed or forwarded to end-host H1 via switch AL3 and access point AP3 before either the timer expires or before the EVPN convergence following the roaming event and can help ensure seamless wireless connectivity with minimal user disruption.

When the configurable timer at wireless access point AP1 expires or when the EVPN/BGP process finally updates the MAC address M of end-host H1 at the distribution layer (aggregation) switches, processing can proceed to block 216. During the operations of block 216, either wireless access point AP1 and/or AP3 can close tunnel 160 (e.g., tunnel 160 can be closed/deactivated in response to the configurable timer expiring). If the EVPN update occurs before the configurable timer expires, then traffic intended for end-host H1 will no longer be sent to AP1, and tunnel 160 will subsequently be deactivated when the configurable timer expires. At this point, any incoming packets intended for end-host H1 will now be properly sent to wireless access point AP3 via switch AL3 without dropping any packets.

The operations of FIG. 5 are merely illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

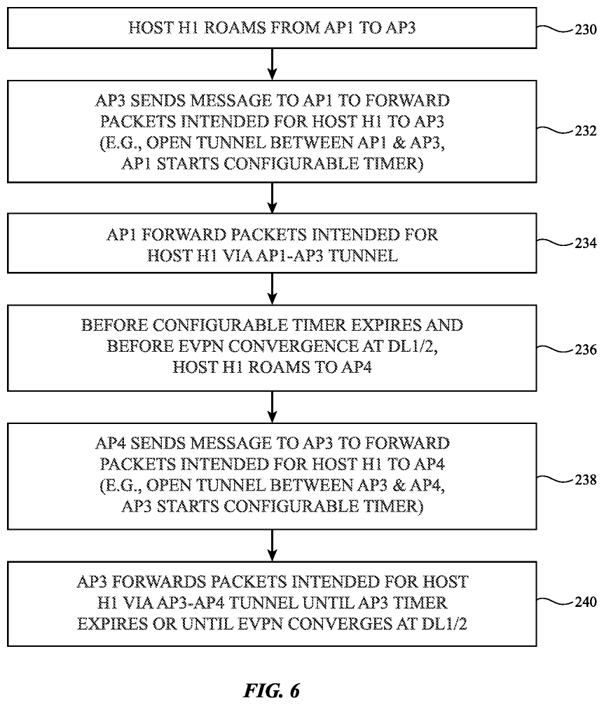

The flow chart of FIG. 5 showing steps during a roaming event from one wireless access point to another wireless access point is illustrative. FIG. 6 is a flow chart of illustrative steps for operating one or more network elements shown in FIG. 4 when end-host H1 roams from wireless access point AP1 to AP3 and, within a few seconds, roams to yet another wireless access point AP4. This is shown in FIG. 4 by arrow 152 when end-host H1 roams from AP3 to AP4. End-host H1 may have an exemplary MAC address M. During the operations of block 230, end-host H1 may roam from wireless access point AP1 to wireless access point AP3. The operations of block 230 in FIG. 6 are at least partially represented by the operations of blocks 200, 202, and 204 in FIG. 5.

During the operations of block 232, wireless access point AP3 can send a message to AP1 directing AP1 to forward packets intended for end-host H1 to AP3. In response to this message, which informs AP1 that AP3 now owns the MAC address M of end-host H1, wireless access point AP1 can create or establish a tunnel (e.g., tunnel 160 in FIG. 4) between AP1 and AP3. In certain embodiments, wireless access point AP3 can create or establish tunnel 160. At this time, wireless access point AP1 can start a configurable timer. The operations of block 232 in FIG. 6 are at least partially represented by the operations of blocks 206, 208, 210, and 212 in FIG. 5.

During the operations of block 234, wireless access point AP1 can forward any incoming data packets intended for end-host H1 to AP3 via tunnel 160. Configured and operated in this way, all traffic intended for end-host H1 will be appropriately directed or forwarded to end-host H1 via switch AL3 and access point AP3 before either the timer expires or before the EVPN convergence following the roaming event and can help ensure seamless wireless connectivity with minimal user disruption. The operations of block 234 in FIG. 6 are at least partially represented by the operations of block 214 in FIG. 5.

During the operations of block 236, end-host H1 roams from AP3 to AP4 (e.g., within a few seconds of arriving at AP3) before the configurable timer at AP1 expires and before the EVPN convergence at the distribution layer switches. This is shown by arrow 152 in FIG. 4.

During the operations of block 238, wireless access point AP4 can send a message to AP3 directing AP3 to forward packets intended for end-host H1 to AP4. In response to this message, which informs AP3 that AP4 now owns the MAC address M of end-host H1, wireless access point AP3 can create or establish a tunnel (e.g., tunnel 162 in FIG. 4) between AP3 and AP4. At this time, wireless access point AP3 can start a configurable timer. Tunnel 162 can be a VXLAN (Virtual Extensible LAN) tunnel, EoGRE (Ethernet over Generic Routing Encapsulation) tunnel, GRE tunnel, BGP tunnel, L2TP (Layer 2 Tunneling Protocol) tunnel, SSL (Secure Sockets Layer) tunnel, PPTP (Point-to-Point Tunneling Protocol) tunnel, MPLS (Multiprotocol Label Switching) tunnel, and/or other types of networking tunnels. Tunnel 162 connecting one wireless AP to another wireless AP can sometimes be referred to and defined herein as an AP-to-AP tunnel. In the example of FIG. 4, tunnel 162 can be coupled through the access layer and distribution layer switches (e.g., see tunnel 162 traversing switches AL3, DL2, and AL4). This is illustrative. In other embodiments, tunnel 162 need not necessarily traverse any distribution layer or aggregation switches so long as an IP route is formed between wireless access points AP3 and AP4.

During the operations of block 240, wireless access point AP3 can now forward any incoming data packets intended for end-host H1 to AP4 via tunnel 162. Configured and operated in this way, all traffic intended for end-host H1 will be appropriately directed or forwarded to end-host H1 via switch AL4 and access point AP4 before either the timer on AP3 expires or before the EVPN convergence following the AP3-to-AP4 roaming event and can help ensure seamless wireless connectivity with minimal user disruption. The operations of block 240 in FIG. 6 are at least partially represented by the operations of block 214 in FIG. 5. Sometime later when the configurable timer at wireless access point AP3 expires or when the EVPN/BGP process finally updates the MAC address M of end-host H1 at the distribution layer (aggregation) switches, either wireless access point AP3 and/or AP4 can close tunnel 162. At this point, any incoming packets intended for end-host H1 will now be properly sent to wireless access point AP4 via switch AL4 without dropping any packets.

The operations of FIG. 6 are merely illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

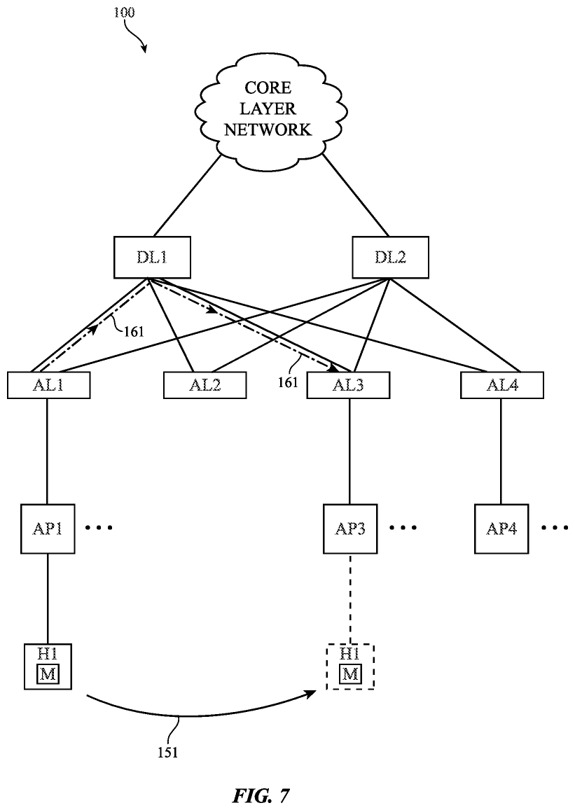

The operations of FIGS. 5 and 6 in which one or more tunnels is established between two different wireless access points are illustrative. FIG. 7 shows another embodiment in which a tunnel can be created or established between two access layer switches. As shown in FIG. 7, end-host H1 roams from wireless access point AP1 to another wireless access point AP3, as indicated by arrow 151. In this example, wireless access point AP1 is connected to switch AL1, whereas AP3 is connected to switch AL3.

In one embodiment, switch AL3 can receive a frame (e.g., either a data frame and a gratuitous frame sent by AP3 to AL3 or only the gratuitous frame sent from AP3) that informs AL3 of the MAC address M being seen by wireless access point AP3, which is connected to AL3. Switch AL3 can then forward the received frame to its CPU (see, e.g., processing circuitry 28 of FIG. 2). The access layer switches can maintain a control protocol among themselves that is used to inform each access layer switch's acquisition of a new MAC address when informed by the access point's gratuitous control frame. The recipient of the gratuitous frame in AL3 is a software agent that updates the switch from which the end-host H1 roamed (e.g., AL1 is updated). The gratuitous frame from AP3 can include the AP name and the switch name from which MAC address M came from. In the example of FIG. 7, the gratuitous frame can include the name of AP1 and the name of switch AL1. Wireless access point AP3 has this information by virtue of the end-host states shared by its radio neighbors, which includes AP1 in this example. AP3 is aware of the fact that AP1 is connected to switch AL1.

Switch AL1 can then remove the MAC address M from the interface connected to AP1 and can then forward all packets with destination MAC address M toward AL3 over a tunnel 161. As shown in FIG. 7, tunnel 161 connects AL1 to AL3 via DL1. Tunnel 161 can be a VXLAN (Virtual Extensible LAN) tunnel, EoGRE (Ethernet over Generic Routing Encapsulation) tunnel, GRE tunnel, BGP tunnel, L2TP (Layer 2 Tunneling Protocol) tunnel, SSL (Secure Sockets Layer) tunnel, PPTP (Point-to-Point Tunneling Protocol) tunnel, MPLS (Multiprotocol Label Switching) tunnel, a virtual tunnel, and/or other types of networking tunnels. Tunnel 161 connecting one access layer switch to another access layer switch can sometimes be referred to and defined herein as a switch-to-switch tunnel. In the example of FIG. 7, tunnel 161 can be coupled through one or more distribution layer switches (e.g., see tunnel 160 traversing at least switch DL1). This is illustrative. In other embodiments, tunnel 161 need not necessarily traverse any distribution layer or aggregation switches so long as an IP route is formed between access layer switches AL1 and AL3.

This forwarding can continue in hardware until the EVPN update indicating that the MAC address M is off of ALL or when a configuration timer expires at AL1. AL1 can maintain a configurable timer which, when expires, will cause ALL to stop forwarding packets to AL3 in the case the EVPN updates fail to come or come later. The timer can have a configurable value that is at least 100 ms (milliseconds), 100-500 ms, 500-1000 ms, at least 1000 ms, 1000-2000 ms, 2000-4000 ms, or more than 4000 ms. The case of roaming between two access points off the same access layer switch can be handled relatively easily, such as by treating such an event as a MAC move between two ports off the same switch, which does not need to involve EVPN.

In another embodiment, in the scenario of FIG. 7 where end-host H1 roams from AP1 to AP3, AP3 can detect the roamed end-host H1 and its MAC address M. AP3 may also be aware of the AP from which end-host H1 roamed (e.g., AP1). Wireless access point AP3 can then send a message to AP1 informing that MAC address M that was previously with AP1 is now with AP3. Wireless access point AP1 can then send a message to AL1 informing that the MAC address M, which switch AL1 was pointing toward AP1, is now with switch AL3. Switch AL1 can then reconfigure its forwarding information base to point toward AL3, so that packets received by AL1 with destination MAC address M are forwarded to AL3. Configured in this way, a virtual switch-to-switch tunnel 161 can be created or established between AL1 and AL3 during the time before the EVPN update indicating that the MAC address M is off of AL1 occurs or before a configuration timer expires at AL1.

The methods and operations described above in connection with FIGS. 1-7 may be performed by the components of one or more network devices and/or server or other host equipment using software, firmware, and/or hardware (e.g., dedicated circuitry or hardware). Software code for performing these operations may be stored on non-transitory computer readable storage media (e.g., tangible computer readable storage media) stored on one or more of the components of the network device(s) and/or server or other host equipment. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device(s) and/or server or other host equipment (e.g., processing circuitry 28 in network device(s) 105, packet processor(s) 32 in network device(s) 105, processing circuitry 92 in wireless access point 110, etc.).

The foregoing is merely illustrative and various modifications can be made to the described embodiments. The foregoing embodiments may be implemented individually or in any combination.

What is claimed is:

1. A method of operating a wireless access point, comprising:
wirelessly connecting with an end-host;
determining whether the end-host has roamed from the wireless access point to an additional wireless access point; and
subsequent to determining that the end-host has roamed from the wireless access point to the additional wireless access point, forwarding a data packet from the wireless access point to the additional wireless access point via a tunnel created between the wireless access point and the additional wireless access point.

2. The method of claim 1, further comprising:
receiving a data packet from an access layer switch; and
conveying the data packet received from the access layer switch to the end-host.

3. The method of claim 2, further comprising:
prior to determining that the end-host has roamed from the wireless access point to the additional wireless access point, conveying host information associated with the end-host to the additional wireless access point.

4. The method of claim 3, wherein conveying the host information comprises conveying a name of the access layer switch to the additional wireless access point prior to determining that the end-host has roamed from the wireless access point to the additional wireless access point.

5. The method of claim 3, wherein conveying the host information comprises conveying an Internet Protocol (IP) address of the access layer switch to the additional wireless access point prior to determining that the end-host has roamed from the wireless access point to the additional wireless access point.

6. The method of claim 3, wherein conveying the host information comprises conveying a media access control (MAC) address of the end-host to the additional wireless access point prior to determining that the end-host has roamed from the wireless access point to the additional wireless access point.

7. The method of claim 6, further comprising:
receiving information from the additional wireless access point that the additional wireless access point has detected the MAC address of the end-host; and
in response to receiving the information from the additional wireless access point that the additional wireless access point has detected the MAC address of the end-host, starting a configurable timer.

8. The method of claim 7, wherein the configurable timer has a duration between 100 milliseconds and 4000 milliseconds.

9. The method of claim of claim 7, further comprising:
in response to the configurable timer expiring, deactivating the tunnel.

10. The method of claim 6, further comprising:
the configurable timer expiring after an Ethernet Virtual Private Network (EVPN) update of the MAC address of the end-host at the access layer switch or a distribution layer switch connected to the access layer switch.

11. The method of claim 6, further comprising:
subsequent to determining that the end-host has roamed from the wireless access point to the additional wireless access point, removing the MAC address of the end-host from a host association table stored on the wireless access point.

12. The method of claim 1, wherein the tunnel comprises a network tunnel selected from the group consisting of: a VXLAN (Virtual Extensible LAN) tunnel, an EoGRE (Ethernet over Generic Routing Encapsulation) tunnel, a GRE (Generic Routing Encapsulation) tunnel, a BGP (Border Gateway Protocol) tunnel, an L2TP (Layer 2 Tunneling Protocol) tunnel, a SSL (Secure Sockets Layer) tunnel, a PPTP (Point-to-Point Tunneling Protocol) tunnel, and an MPLS (Multiprotocol Label Switching) tunnel.

13. A method of operating a network device, comprising:
sending data packets to an end-host;
determining whether the end-host has roamed from a first wireless coverage area to a second wireless coverage area; and
subsequent to determining that the end-host has roamed from the first wireless coverage to the second wireless coverage area, temporarily forwarding additional data packets intended for the end-host to an additional network device.

14. The method of claim 13, further comprising:
subsequent to determining that the end-host has roamed from the first wireless coverage to the second wireless coverage area, creating a tunnel between the network device and the additional network device, wherein the additional data is forwarded to the additional network device through the tunnel.

15. The method of claim 14, further comprising:
subsequent to determining that the end-host has roamed from the first wireless coverage to the second wireless coverage area, starting a configurable timer.

16. The method of claim 15, wherein the configurable timer has a duration between 100 milliseconds and 4000 milliseconds.

17. The method of claim 14, further comprising:
closing the tunnel in response to the configurable timer expiring or in response to an Ethernet Virtual Private Network (EVPN) update of the end-host occurring at an aggregation switch associated with the network device.

18. An access point comprising:
wireless circuitry configured to communicate with an end-host and a neighboring access point;
memory circuitry configured to store a host association table listing a media access control (MAC) address of the end-host; and
processing circuitry configured to
determine whether the end-host has roamed from the access point to the neighboring access point, and
forward data packets intended for the end-host to the neighboring access point via a tunnel established between the access point and the neighboring access point.

19. The access point of claim 18, wherein the processing circuitry is further configured to:
start a configurable timer subsequent to determining that the end-host has roamed from the access point to the neighboring access point; and
deactivate the tunnel when the configurable timer expires.

20. The access point of claim 18, wherein the processing circuitry is further configured to:
deactivate the tunnel in response to a Border Gateway Protocol (BGP) update of the end-host occurring at an aggregation switch or an access layer switch associated with the access point.
